(19) United States
(12) Patent Application Publication
(10) Pub. No.: US 2005/0271998 A1
(43) Pub. Date: Dec. 8, 2005

(54) Tooth-cleaning device having inspecting function

(76) Inventor: Kung-Nan Chi, Tainan City (TW)

Correspondence Address: Kung-Nan Chi, P.O. Box 90, Tainan City, 704, TW

(21) Appl. No.: 10/861,382

(22) Filed: Jun. 7, 2004

(51) Int. Cl. A61C 3/00; A61C 17/02

(52) U.S. Cl. 433/29; 433/80; 601/162

(57) ABSTRACT

A tooth-cleaning device having inspecting function includes a main body and a tooth-cleaning apparatus. The main body is provided therein with a circuit unit and a water tank. The circuit unit is connected with a conductive wire extending out of the main body connected with an external water pipe communicating with the water tank and having one outer side provided with a screen connected with the circuit unit. The tooth-cleaning apparatus is connected with the conductive wire and the water pipe of the main body and a lens is connected with the conductive wire. Thus, when a user cleans his teeth with the tooth-cleaning apparatus, his teeth can have their image transmitted by the lens to the screen of the main body, enabling a user to inspect the condition of his teeth being cleaned.

### BACKGROUND OF THE INVENTION

1. Field of the Invention

This invention relates to a tooth-cleaning device having inspecting function, particularly to one having a main body provided with a circuit unit and a water tank in the interior. The circuit unit is connected with a conductive wire extending out of the main body, which is connected with an external water pipe communicating with the water tank. Further, the main body is provided on one outer side with a screen connected with the circuit unit and has the conductive wire and the water pipe connected with a tooth-cleaning apparatus, with a lens connected with the conductive wire. Thus, when a user cleans his teeth with the tooth-cleaning apparatus, his teeth can have their image transmitted by the lens to the screen of the main body to let the user inspect the condition of his teeth being cleaned.

2. Description of the Prior Art

Generally, to keep the cavity of a mouth clean, most people always brush teeth after getting up and before going to bed and also rinsing the mouth with water (or mouthwash) or picking teeth with a dental floss or a toothpick after eating. Although the above-mentioned methods could clean the cavity of a mouth to a certain extent, yet if a user holds a toothbrush at wrong angles or brushes his teeth in wrong directions or applies force improperly, his teeth can hardly be brushed clean, especially his premolars or molars, the space between every two teeth and the root of the teeth, and even certain teeth and gums may be damaged. Although a tooth-flushing apparatus has function of scouring off dregs of food left on teeth by means of water sprayed, yet a user wishing to check the condition of his teeth after cleaned has to stand before a mirror, open his mouth widely and expose his teeth for inspection, looking a little ungraceful and unbecoming.

### SUMMARY OF THE INVENTION

The objective of the invention is to offer a tooth-cleaning device having inspecting function, able to clean up a user's teeth and have the image of his teeth transmitted at the same time by a lens provided thereon to a screen provided on one side of a main body, enabling the user to inspect the condition of his teeth being cleaned.

A first feature of the invention is a main body provided with a circuit unit and a water tank in the interior. The circuit unit is connected with a conductive wire extending out of the main body connected with an external water pipe communicating with the water tank and having one outer side provided with a screen connected with the circuit unit. A tooth-cleaning apparatus is connected with the conductive wire and the water pipe of the main body and provided with a lens.

A second feature of the invention is a main body provided with a circuit unit and a water tank in the interior. The circuit unit is connected with a conductive wire extending out of the main body connected with an external water pipe communicating with the water tank and having one outer side provided with a screen connected with the circuit unit. A tooth-cleaning apparatus is connected with the conductive wire and the water pipe of the main body and a lens is connected with the circuit unit and the conductive wire of the main body.

### BRIEF DESCRIPTION OF DRAWINGS

This invention will be better understood by referring to the accompanying drawings, wherein:

FIG. 1 is a first perspective view of a first preferred embodiment of a tooth-cleaning device having inspecting function in the present invention;

FIG. 2 is a second perspective view of the first preferred embodiment of the tooth-cleaning device having inspecting function in the present invention;

FIG. 3 is a perspective view of the first preferred embodiment of the tooth-cleaning device having inspecting function in a using condition in the present invention; and,

FIG. 4 is a perspective view of a second preferred embodiment of a tooth-cleaning device having inspecting function in the present invention.

### DETAILED DESCRIPTION OF THE PREFERRED EMBODIMENT

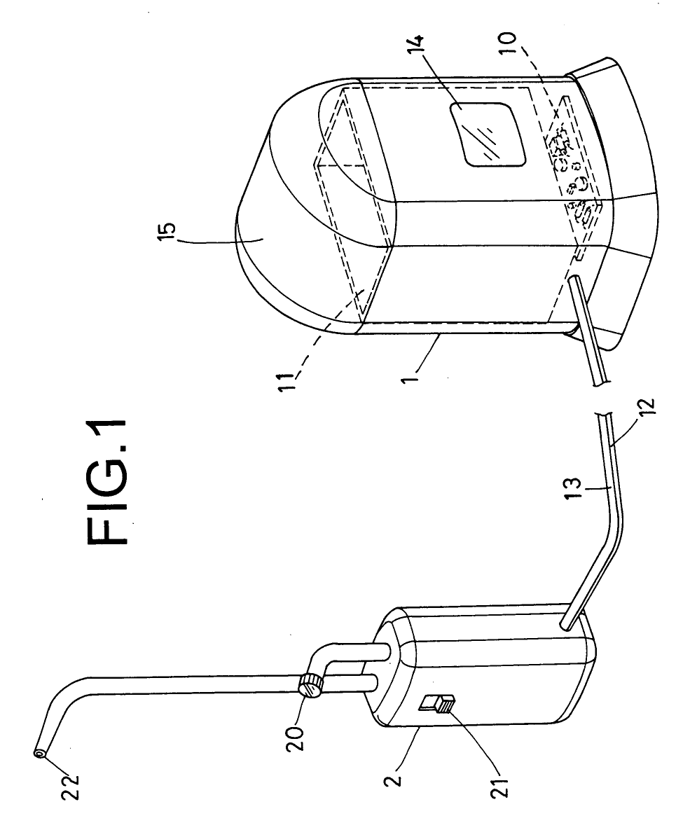

A first preferred embodiment of a tooth-cleaning device having inspecting function in the present invention, as shown in FIGS. 1, 2 and 3, includes a main body 1 and a tooth-cleaning apparatus 2 combined together.

The main body 1 is provided with a circuit unit 10 and a water tank 11 in the interior. The circuit unit 10 is connected with a conductive wire 12 extending out of the main body 1. The main body 1 is further connected with an external water pipe 13 communicating with the water tank 11 and has one outer side provided with a screen 14 connected with the circuit unit 10, with a lifting cover 15 assembled above the water tank 11.

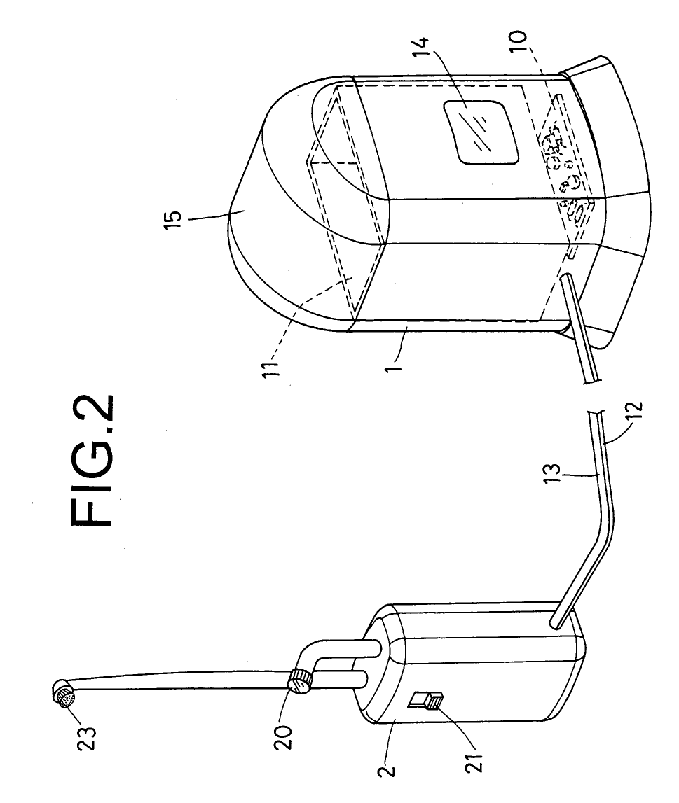

The tooth-cleaning apparatus 2 is connected with the conductive wire 12 and the water pipe 13 of the main body 1, having a lens 20 and a change-over switch 21 provided on an outer surface. The tooth-cleaning apparatus 2 is provided with a water-spraying tube 22 extending up, as shown in FIG. 1, and a tooth brush 23 fitted on an upper end of the tube 22 as shown in FIG. 2.

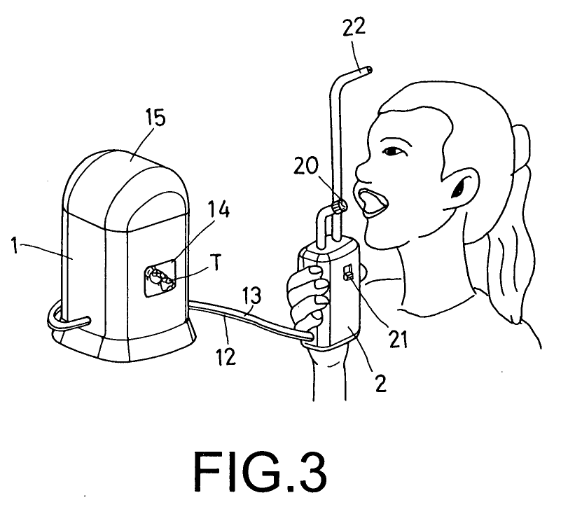

Thus, when a user cleans his teeth with the tooth-cleaning apparatus 2, his teeth can have their image transmitted by the lens 20 to the screen 14, and the teeth (T) can be inspected on the screen 14 by the user, as shown in FIG. 3.

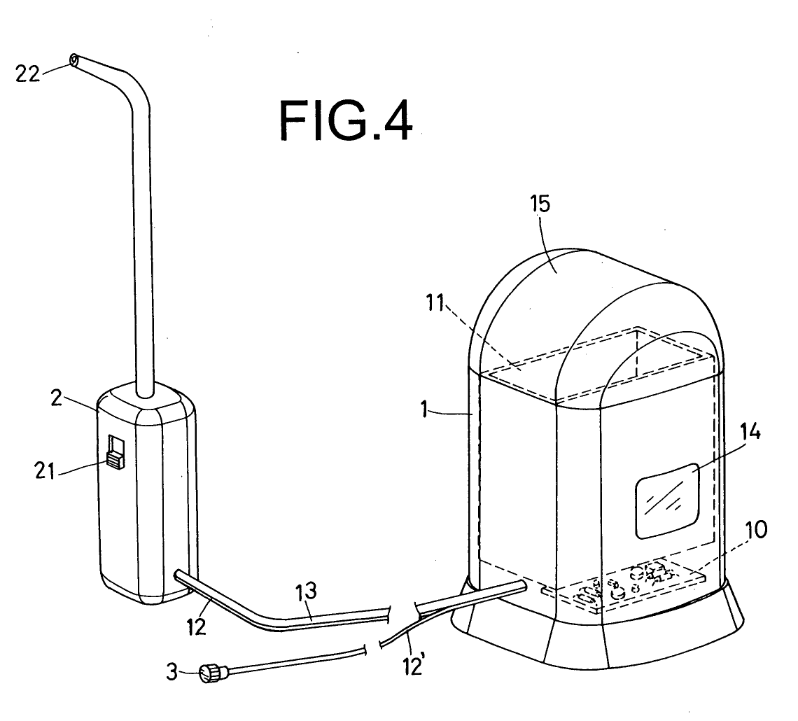

A second preferred embodiment of a tooth-cleaning device having inspecting function in the present invention, as shown in FIG. 4, includes a main body 1 and a tooth-cleaning apparatus 2 combined together.

The main body 1 is provided with a circuit unit 10 and a water tank 11 in the interior. The circuit unit 10 is connected with a conductive wire 12′ extending out of the main body 1. The main body 1 is connected with an external water pipe 13 communicating with the water tank 11 and has one outer side provided with a screen 14 connected with the circuit unit 10 and also a lifting cover 15 provided above the water tank 11.

The tooth-cleaning apparatus 2 is connected with the conductive wire 12′ and the water pipe 13 of the main body 1 and provided with a change-over switch 21 on an outer surface, a water-spraying tube 22 extending up and a tooth brush 23 fitted on an upper end of the tube 22. A lens 3 is independently provided, not fixed on the upper side of the apparatus 2, connected with the circuit unit 10 of the main body 1 by the conductive wire 12′, which forms the different structure from the first embodiment.

Thus, a user's teeth can have their image transmitted by the lens 3 to the screen 14, and the condition of the teeth being cleaned can be inspected on the screen 14 of the main body 1.

While the preferred embodiments of the invention have been described above, it will be recognized and understood that various modifications may be made therein and the appended claims are intended to cover all such modifications that may fall within the spirit and scope of the invention.

1. A tooth-cleaning device having inspecting function comprising:
a main body provided with a circuit unit and a water tank in its interior, said circuit unit connected with a conductive wire extending out of said main body, said main body connected with an external water pipe communicating with said water tank, said main body having one outer side provided with a screen, said screen connected with said circuit unit;
a tooth-cleaning apparatus connected with said conductive wire and said water pipe of said main body, said tooth-cleaning apparatus provided thereon with a lens; and,
a user able to clean his teeth with said tooth-cleaning apparatus and have the image of his teeth transmitted by said lens to said screen, the image of his teeth shown on said screen of said main body, a user able to inspect the condition of his teeth being cleaned on said screen.

2. A tooth-cleaning device having inspecting function comprising:
a main body provided therein with a circuit unit and a water tank, said circuit unit connected with a conductive wire extending out of said main body, said main body connected with an external water pipe communicating with said water tank, said main body having one outer side provided with a screen, said screen connected with said circuit unit;
a tooth-cleaning apparatus connected with said conductive wire and said water pipe of said main body; and,
a lens connected with said circuit unit of said main body by said conductive wire.

3. The tooth-cleaning device having inspecting function as claimed in claim 1, wherein said tooth-cleaning apparatus is provided with a water-spraying tube.

4. The tooth-cleaning device having inspecting function as claimed in claim 2, wherein said tooth-cleaning apparatus is provided with a water-spraying tube.

5. The tooth-cleaning device having inspecting function as claimed in claim 1, wherein said tooth-cleaning apparatus is provided with a toothbrush.

6. The tooth-cleaning device having inspecting function as claimed in claim 2, wherein said tooth-cleaning apparatus is provided with a toothbrush.

7. The tooth-cleaning device having inspecting function as claimed in claim 1, wherein said tooth-cleaning apparatus is provided with a change-over switch for facilitating operation of tooth cleaning.

8. The tooth-cleaning device having inspecting function as claimed in claim 2, wherein said tooth-cleaning apparatus is provided with a change-over switch for facilitating operation of tooth cleaning.
